(19) United States
(12) Patent Application Publication
(10) Pub. No.: US 2011/0020722 A1
(43) Pub. Date: Jan. 27, 2011

(54) FUEL CELL AND BIPOLAR PLATE HAVING MANIFOLD SUMP

(76) Inventors: Jeffrey G. Lake, Vernon, CT (US); David A. Niezelski, Manchester, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/933,755

(22) PCT Filed: Apr. 11, 2008
(86) PCT No.: PCT/US2008/059971

§ 371 Date: Sep. 21, 2010

(51) Int. Cl. H01M 8/04

(52) U.S. Cl. 429/444; 429/514

(57) ABSTRACT

A device for use in a fuel cell includes a bipolar plate having flow field channels, a manifold fluidly connected with the flow field channels for conveying a reactant gas, and a sump fluidly connected with the manifold.

### BACKGROUND OF THE DISCLOSURE

This disclosure relates to fuel cells. More particularly, this disclosure relates to a fuel cell and bipolar plate having a manifold and a sump connected with the manifold for collecting water to facilitate reduction of an amount of the water in the manifold.

Fuel cells are widely known and used for generating electricity for a variety of uses. Typically, a fuel cell unit includes an anode, a cathode, and an ion-conducting polymer exchange membrane (PEM) between the anode and the cathode. The anode and cathode are between bipolar plates (also referred to as transport plates) that include flow field channels and manifolds for circulating reactant gases through the flow field channels to the PEM and generating electricity in a known electro-chemical reaction.

One problem associated with fuel cells relates to water in the reactant gases. Water vapor that is carried in the reactant gases may condense and collect in the manifolds. In a supply manifold, the condensed water may block entry of fuel reactant gas into the flow field channels and cause “starvation” of the fuel cell. In an exit manifold, the water may block discharge of oxygen reactant gas from the flow field channels and cause an increase in pressure loss across the fuel cell and a corresponding loss of operation efficiency.

### SUMMARY OF THE DISCLOSURE

The disclosed example bipolar plates and fuel cell are for facilitating reduction of water blockage of reactant gas flow fields due to water accumulation in reactant gas manifolds.

In one example, a bipolar plate includes flow field channels, a manifold fluidly connected with the flow field channels for conveying a reactant gas, and a sump fluidly connected with the manifold for collecting water from the reactant gas.

The bipolar plate may be one of a plurality of bipolar plates used in a fuel cell that includes at least one electrode. Each of the bipolar plates may include sumps for collecting water from the reactant gas. Some of the bipolar plates may also include a baffle for inhibiting motion of water accumulated therein.

An example method of controlling a fuel cell having at least one bipolar plate that includes flow field channels and a manifold fluidly connected with the flow field channels includes establishing a sump that is fluidly connected with the manifold, and collecting water in the sump to thereby control an amount of the water in the manifold.

### BRIEF DESCRIPTION OF THE DRAWINGS

The various features and advantages of this disclosure will become apparent to those skilled in the art from the following detailed description of the currently preferred embodiment. The drawings that accompany the detailed description can be briefly described as follows.

FIG. 1 illustrates an exploded view of selected portions of an example fuel cell.

FIG. 2 illustrates an example bipolar plate used in the fuel cell of FIG. 1.

FIG. 3 illustrates a section of the bipolar plate according to FIG. 2.

FIG. 4 illustrates the bipolar plate with optional coolant channels.

FIG. 5 illustrates another example bipolar plate of the fuel cell of FIG. 1.

FIG. 6 illustrates the other side of the bipolar plate of FIG. 5.

FIG. 7 illustrates a section of the bipolar plate according to FIG. 6.

### DETAILED DESCRIPTION OF THE PREFERRED EMBODIMENT

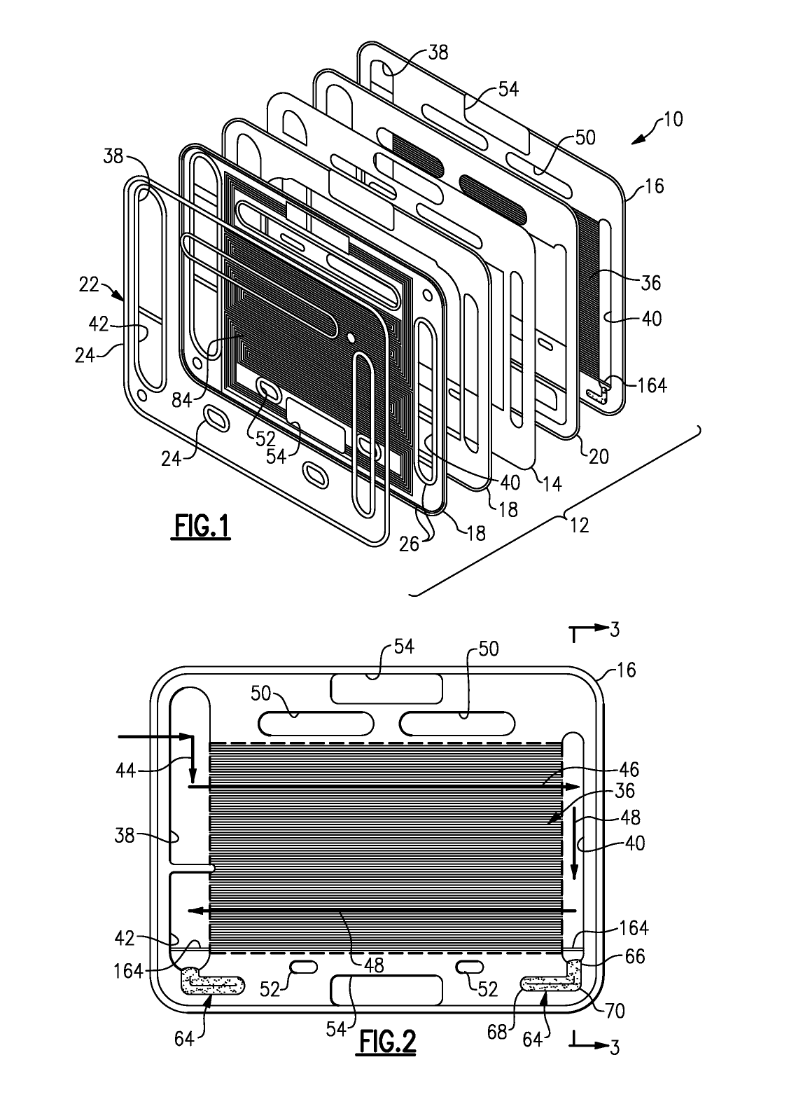

FIG. 1 schematically illustrates an exploded view of selected portions of an example fuel cell 10 for generating electricity. In the illustrated example, the fuel cell 10 includes at least one unitized cell 12. For example, a plurality of the unitized cells 12 may be used to form a fuel cell stack, depending on the desired amount of electricity to be generated. As is known, the unitized cell 12, or alternatively a fuel cell stack having multiple unitized cells 12, may be secured between pressure plates in a known manner to form the fuel cell 10. Furthermore, the fuel cell 10 may include various additional components that are not illustrated, such as components associated with the supply or return of reactant gases, coolant water, etc. Given this description, one of ordinary skill in the art would recognize that the disclosed examples are applicable to a variety of different fuel cell configurations.

In the disclosed example, the unitized cell 12 includes a membrane electrode assembly (MEA) 14 located between a first bipolar plate 16 and a second bipolar plate 18, which may be referred to as anode and cathode bipolar plates depending on the location relative to the MEA 14 electrodes. For example, the MEA 14 includes a cathode catalyst electrode, an anode catalyst electrode, and a polymer exchange membrane, but is not limited to any specific configuration.

The first bipolar plate 16 and the second bipolar plate may be formed from a porous material, such as graphite or other porous material, which permits transport of water there through. Alternatively, the first bipolar plate 16, the second bipolar plate 18, or both may be solid, depending on the type of fuel cell 10.

In the illustrated example, the first bipolar plate 16, the second bipolar plate 18, and the MEA 14 are secured together using bonding films 20. For example, the bonding film 20 is a relatively thin layer of low density polyethylene.

In the disclosed example, the unitized cell 12 utilizes a gasket system 22 to seal the unitized cell 12 and prevent intermixing of the reactant gases and coolant water. For example, the gasket system 22 includes one or more gaskets 24 that are received into gasket channels 26 within the second bipolar plate 18. In other examples, the gaskets 24 may be received into gasket channels in the first bipolar plate 16. Additional gaskets may also be used, depending on the particular configuration of the fuel cell 10.

The first bipolar plate 16 is also shown in FIG. 2 and includes a flow field 36 for distributing fuel reactant gas to the MEA 14. The first bipolar plate 16 also includes a supply manifold 38, a turn manifold 40, and an exit manifold 42. The supply manifold 38 distributes fuel reactant gas to the flow field 36, as represented by arrows 44. The fuel reactant gas flows through the flow field 36, as represented by the arrow 46. The turn manifold 40 turns the flow of the fuel reactant gas for a second pass though the flow field 36, as represented by arrow 48. The exit manifold 42 discharges any unused fuel reactant gas from the flow field 36.

The first bipolar plate 16 also includes supply manifolds 50 for supplying oxygen reactant gas to the second bipolar plate 18. Exit manifolds 52 discharge the oxygen reactant gas from the second bipolar plate 18, and coolant manifolds 54 circulate coolant (e.g., water) to the second bipolar plate 18. The supply manifolds 50, exit manifolds 52, and coolant manifolds 54 are not directly fluidly connected with the flow field 36.

In the disclosed example, each of the turn manifold 40 and the discharge manifold 42 include a sump 64 for collecting water from the respective manifolds 40 and 42. For example, the water may condense from the fuel reactant gas. Alternatively, depending on a particular fuel cell design, it may be desirable to provide only one of the manifolds 40 or 42 with a sump 64.

The sumps 64 may also be any suitable shape for collecting the water to facilitate reduction of an amount of the water within the manifolds 40 and 42. In some examples, the sumps 64 are of suitable size to collect all of the water such that the water does not block entrances or exits of the channels of the flow field 36. The sumps 64 thereby also provide the benefit of facilitating reduction of fuel starvation and pressure loss through the flow field 36.

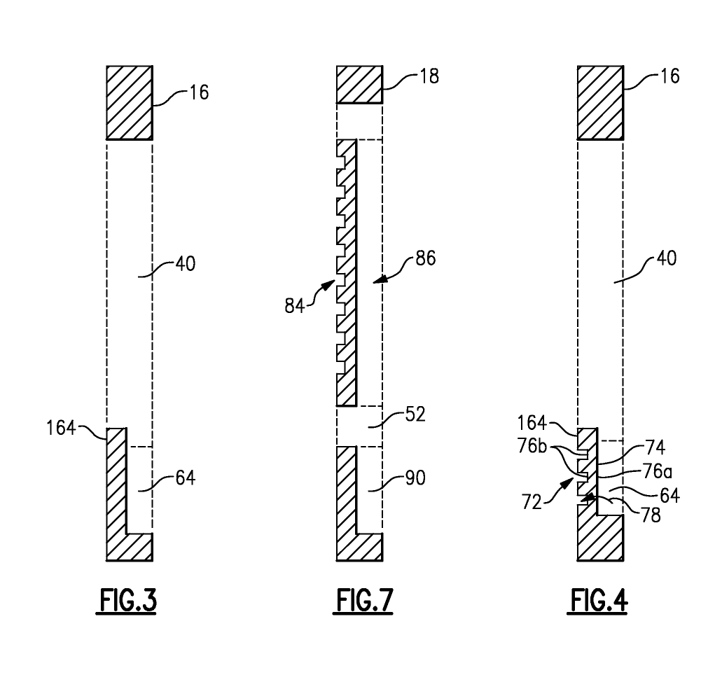

Referring also to FIG. 3, which illustrates a section of the first bipolar plate 16 according to the sections shown in FIG. 2, the sump 64 is formed by a channel that extends partially through the thickness of the first bipolar plate 16. Once assembled into the fuel cell 10, the sump 64 is bound (relative to FIG. 3) on the left side and bottom by walls of the first bipolar plate 16 and on the right side by the second bipolar plate 18 (of a neighboring unitized cell 12), with the top being open via throat portion 66 to the turn manifold 40 (or alternatively, the exit manifold 42).

In one example, the channel may be formed in a manner similar to that which is used for forming the channels of the flow field 36, such as by machining or by using a molding process.

In the disclosed example, each of the sumps 64 includes a throat portion 66 (FIG. 2), a reservoir portion 68, and a curved channel section 70 connecting the throat portion 66 and the reservoir portion 68. As can be appreciated, gravitational force causes any liquid water within the manifolds 40 and 42 to flow down into the sumps 64 through the throat portion 66. The water then flows into the reservoir sections 68 through the curved channel section 70 and is thereby contained within the sumps 64.

In the disclosed example, the curved channel section 70 provides a turn of about 90° between the throat portion 66 and the reservoir portion 68 to facilitate containment of the water within the sump 64. Thus, even if the first bipolar plate 16 is tilted (e.g., when a vehicle in which the fuel cell 10 is used tilts), the sump 64 contains the water. For example, if the first bipolar plate 16 is rotated counter-clockwise in FIG. 2, any water in the sump 64 that is connected with the turn manifold 40 would flow toward the left end of the reservoir portion 68 and thereby be contained within the sump 64. Any water in the sump 64 connected with the exit manifold 42 would flow toward the throat portion 66 or, if there is a relatively large amount of water, toward the throat portion 66 and the left-side wall of the exit manifold 42 and thereby not block the exits of the channels of the flow field 36.

Additionally, if multiple first bipolar plates 16 having sumps 64 are used in a fuel cell stack, the sumps 64 function as baffles to facilitate reduction of sloshing of any water in the manifolds 40 and 42. Thus, the sumps 64 may either contain the water or limit exposure of the entries and exits of the channels of the flow field 36 to the water and thereby control blockage.

The shape of the sumps 64 may also be adapted to an existing bipolar plate to maintain compactness of a bipolar plate. That is, the sumps 64 may be formed into unused space of an existing bipolar plate, such as space that does not include coolant channels or gasket channels. In this regard, the sumps 64 may be “retrofit” to existing bipolar plates using a machining or other suitable forming process.

Optionally, as illustrated in FIG. 4, the first bipolar plate 16 may also include coolant channels 72 located near the sump 64 that are in fluid connection with at least one of the coolant manifolds 54 for circulating coolant water. In the illustrated example, the coolant channels 72 are formed on an opposite side of the first bipolar plate 16 relative to the sump 64. In this example, the coolant channels 72 and the sump 64 share a common wall 74 that forms a surface 76a of the sump 64 and surfaces 76b of the coolant channels 72.

In examples where the first bipolar plate 16 is formed from a porous material, the coolant channels 72 facilitate removal of water from the sump 64. For example, a water pressure within the coolant channel 72 is less than a water pressure within the sump 64 to thereby urge any water within the sump 64 to move through the pores of the common wall 74 from the sump 64 into the coolant channel 72, as indicated by arrow 78. Thus, even if water is collected within the sump 64, the coolant channels 72 remove the water to thereby control water accumulation. The magnitude of the pressure difference may be controlled in a known manner through control of the water flow though the coolant channels 72 and control of a reactant gas pressure, such as by using pumps, valves, or the like.

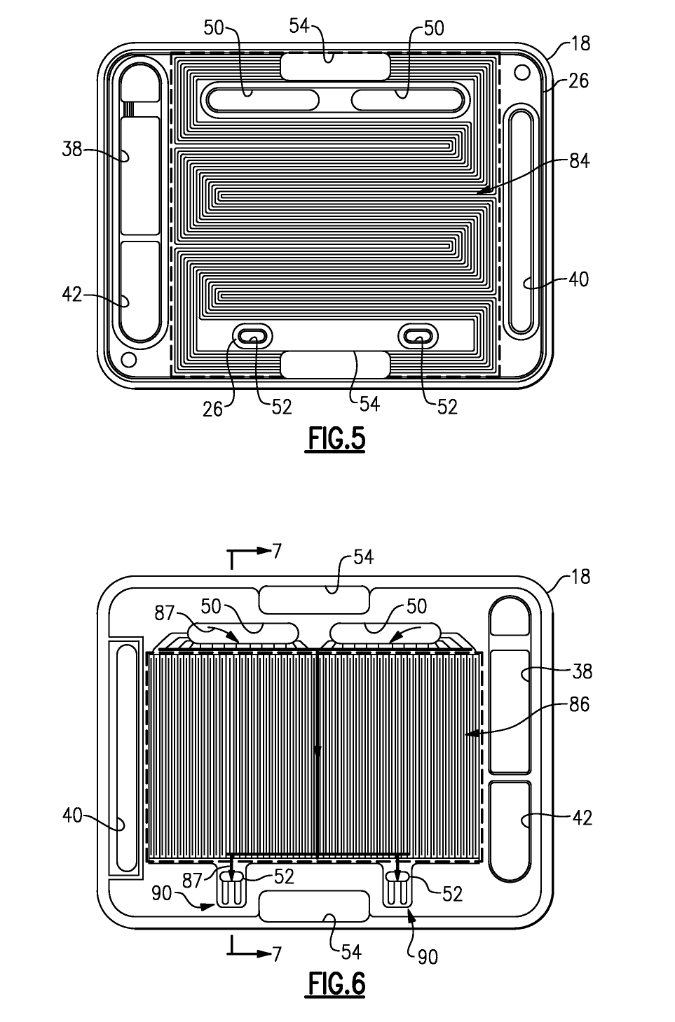

The second bipolar plate 18 is also shown in FIG. 5, and the other side of the second bipolar plate 18 that is not visible in FIGS. 1 and 5 is shown in FIG. 6. The second bipolar plate 18 includes a coolant flow field 84 on one side and an oxygen flow field 86 on its other side. Similar to the first bipolar plate 16, the second bipolar plate 18 includes various openings that function as manifolds for supplying or discharging reactant gasses or coolant. For example, the second bipolar plate 18 includes the coolant manifolds 54 for supplying the coolant to the coolant flow field 84.

Referring to FIG. 6, the supply manifolds 50 and exit manifolds 52 extend through the second bipolar plate 18 for circulating oxygen reactant gas to the oxygen flow field 86, as indicated by arrows 87. The supply manifolds 50 distribute oxygen reactant gas to inlets of the channels of the oxygen flow field 86. Likewise, the channels of the oxygen flow field 86 include exits that discharge any unused oxygen reactant gas to the exit manifolds 52.

Additionally, the supply manifold 38, turn manifold 40, and exit manifold 42 extend through the second bipolar plate 18 for circulating the fuel reactant gas to the first bipolar plate 16, as described above. The supply manifold 38, the turn manifold 40, and the exit manifold 42 are not directly fluidly connected with the channels of the coolant flow field 84 or the oxygen flow field 86.

In the illustrated example, each of the exit manifolds 52 includes a sump 90 for collecting condensed water therein. As can also be appreciated from FIG. 7, the sumps 90 are located near the bottoms of the exit manifolds 52 such that any water in the exit manifolds 52 will gravitationally flow into the sumps 90 to thereby prevent blockage of the exits of the channels of the flow field 86. Thus, the sumps 90 provide similar advantages to the sumps 64, as discussed above.

In the illustrated example, each of the sumps 90 is a channel that extends partially through the thickness of the second bipolar plate 18. Once assembled into the fuel cell 10, the sump 90 is bound (relative to FIG. 7) on the left side and bottom by walls of the second bipolar plate 18 and on the right side by the MEA 14, with the top being open to the exit manifold 52. Alternatively, the sumps 90 could be formed into the other side of the second bipolar plate 18 such that the left sides of the sumps 90 would be bound by the first bipolar plate 16 of a neighboring unitized cell 12. Additionally, the second bipolar plate 18 may include adjacent coolant channels, similar to the coolant channels 72 shown in FIG. 4, to facilitate water removal from the sumps 90. Similar to the sumps 64, the sumps 90 may also be any suitable shape or size for collecting water to prevent blockage and may be “retrofit” to existing bipolar plates.

In the disclosed example, each sump 90 is a generally rectangular channel located below the exit manifolds 52. However, in other examples, it may be desirable to also provide the sumps 90 with a curved channel section, similar to the sump 64, for an even greater degree of water containment. However, in some fuel cell designs, blockage of the exits of the channels of the flow field 86 may be somewhat less of a concern than blockage of the fuel channels of the flow field 36 because blockage of oxygen reactant gas flow would not cause fuel starvation and would mainly result in pressure loss and loss of efficiency.

In addition to the sumps 64 inherently functioning as baffles as described above, the bipolar plates 16 may also include discrete baffle members 164, as depicted in FIGS. 1-4. The baffles 164 are formed by extensions of the bipolar plate 16 a short distance upward beyond the throat portions 66 and into the manifolds 40 and 42. The baffles 164 serve to impede the flow of water in the manifolds 40 and 42 in a longitudinal direction through the thickness of the cell 10, to facilitate further reduction of sloshing of water. Although only baffles 164 in conjunction with manifolds 40 and 42 in bipolar plates 16 have been described in detail, it will be understood that additional baffles 164 having a similar function may also be included in the manifolds 52.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A device for use in a fuel cell, comprising:
a bipolar plate including flow field channels, a manifold fluidly connected with the flow field channels for conveying a reactant gas, and a sump fluidly connected with the manifold.

2. The device as recited in claim 1, wherein the manifold comprises a reactant gas supply manifold.

3. The device as recited in claim 1, wherein the manifold comprises a reactant gas turn manifold.

4. The device as recited in claim 1, wherein the manifold comprises a reactant gas discharge manifold.

5. The device as recited in claim 1, wherein the sump comprises a channel that extends partially through the bipolar plate.

6. The device as recited in claim 5, wherein the channel includes a curved channel section.

7. The device as recited in claim 6, wherein the curved channel section turns about 90°.

8. The device as recited in claim 1, wherein the manifold includes a top end and a bottom end, and the sump extends from the bottom end.

9. The device as recited in claim 1, wherein the bipolar plate comprises coolant channels adjacent the sump.

10. The device as recited in claim 9, wherein the coolant channels and the sump share a common wall that forms a surface of the sump and a surface of the coolant channels.

11. The device as recited in claim 1, wherein the bipolar plate comprises a porous material.

12. The device as recited in claim 1 wherein the bipolar plate includes a baffle proximate the sump and extending into the manifold for impeding motion of a liquid.

13. A fuel cell comprising:
at least one electrode;
a plurality of bipolar plates associated with the at least one electrode, each of the bipolar plates including flow field channels and a manifold fluidly connected with the flow field channels for conveying a reactant gas, and the plurality of bipolar plates each include a sump fluidly connected with the manifold.

14. The fuel cell as recited in claim 13 wherein at least one of the plurality of bipolar plates includes a baffle proximate the sump and extending into the manifold for impeding motion of a liquid in the fuel cell.

15. A method of controlling a fuel cell having at least one bipolar plate that includes flow field channels and a manifold fluidly connected with the flow field channels for conveying a reactant gas, comprising:
establishing a sump that extends from the manifold; and
collecting water in the sump to thereby control an amount of the water in the manifold.

16. The method as recited in claim 15, further comprising controlling a pressure difference between the sump and a coolant channel located adjacent to the sump to thereby urge any water in the sump to move through pores of the bipolar plate from the sump toward the coolant channel.
